(19) United States
(12) Patent Application Publication
(10) Pub. No.: US 2014/0042818 A1
(43) Pub. Date: Feb. 13, 2014

(54) PHOTOVOLTAIC POWER PLANT

(71) Applicant: AEG POWER SOLUTIONS B.V., Zwanenburg (NL)

(72) Inventors: Norbert Blacha, Warstein (DE); Stefan Kempen, Arnsberg (DE)

(73) Assignee: AEG POWER SOLUTIONS B.V., Zwanenburg (NL)

(21) Appl. No.: 13/745,108

(22) Filed: Jan. 18, 2013

(30) Foreign Application Priority Data
Aug. 7, 2012 (EP) 12 179 571.0

(51) Int. Cl. H02J 1/00

(52) U.S. Cl. CPC H02J 1/00
USPC 307/77

(57) ABSTRACT

A photovoltaic power plant with photovoltaic modules (1) for generating electric power. The modules (1) are connected together into a plurality of strands (2). A first central converter (5) for converting electrical energy generated by the photovoltaic modules into electrical energy with a voltage having a voltage waveform that corresponds to a voltage waveform of a voltage in a utility grid, and with an output for feeding the converted current into the utility grid, wherein the first central converter (5) has at least one electric motor (51) and a synchronous generator (52) whose shafts are coupled to one another.

### BACKGROUND OF THE INVENTION

The present invention relates to a photovoltaic power plant with photovoltaic modules for power generation, which are connected together to form a plurality of strands, wherein the strands are connected in parallel. A first central converter for converting electrical energy generated by the photovoltaic modules into electrical energy with a voltage having a voltage waveform that corresponds to a voltage waveform of a voltage in a utility grid, and with an output for supplying the converted power into the utility grid.

Photovoltaic power plants are now commonplace in many parts of the world. In addition to photovoltaic power plants in stand-alone operation, which usually have only small output power, photovoltaic power plants connected to the utility grid are much more important. Unlike photovoltaic power plants in stand-alone operation, power plants connected to the utility grid usually do not save the generated electrical energy and instead feed the energy to a power grid. The fed grid may be a low-voltage grid, an intermediate voltage grid or a high voltage grid; in Germany, electrical power is currently typically supplied at the lower or intermediate grid level, i.e. in the low-voltage grid or in the intermediate voltage grid.

Steam power plants and hydroelectric power plants are the principal suppliers of electrical energy in most industrialized countries of the world. Steam power plants convert chemical energy from coal, gas or oil or nuclear energy into electrical energy. Hydroelectric power plants generate electrical energy from the kinetic energy of water. Synchronous generators are typically driven by the steam or water, which provide at the outputs of the power plant a sinusoidal voltage which is then introduced into the utility grid. The voltage generated by the synchronous generators is almost free of harmonics and sub-harmonics.

This cannot be achieved with photovoltaic power plants without a special effort, because the photovoltaic modules of a photovoltaic power plant initially provide a DC voltage, which is converted into alternating current by inverters, for example strand inverters or central inverters. The conversion is performed by high-power electronic components which are now available in large quantities and at a reasonable price. However, the voltage supplied by the inverter is technically not free from harmonics or sub-harmonics. Therefore, a considerable effort is made in these days to filter out the harmonics or sub-harmonics before feeding the generated electrical energy into the utility grid. The effort is quite significant especially for large photovoltaic power plants.

Before a photovoltaic power plant can be connected to a utility grid, it must be demonstrated to the grid operator that the requirements from the grid operator for feeding electrical energy are met. The underlying principle is hereby that the proof becomes more rigorous, the greater the output of the plant.

It is the goal of the invention to reduce this effort.

### BRIEF SUMMARY OF THE INVENTION

It is the object of the invention to improve a photovoltaic power plant further so that electrical energy generated by photovoltaic power plants can be supplied substantially free from harmonics and sub-harmonics.

This object is attained with the invention in that the first central converter of the photovoltaic power plant has at least one electric motor and a synchronous generator, whose shafts are coupled with each other.

The historical development of photovoltaic power plants starts with photovoltaic pioneers who in the eighties and nineties of the last century connected the first small photovoltaic power plants with lower output power to a utility grid in order to inject energy into the grid. The photovoltaic power plants which were partly built by these photovoltaic pioneers themselves included inverters, which are still in use today in their basic form. The technology behind these power semiconductor elements and the inverters constructed therefrom has steadily improved ever since. The power-handling capacity of the modules and inverters has increased, making increasingly bigger photovoltaic power plants possible, so that photovoltaic power plants with a power output of several megawatts are feasible today.

Basically little changed in the past in the topology of photovoltaic power plants. The direct current must still be converted into alternating current with an inverter having power semiconductors before being fed into the grid. It is not known whether other developments were pursued.

### BRIEF SUMMARY OF THE INVENTION

The type of conversion according to the invention of the direct current into alternating current with an electric motor and a synchronous generator provides a number of advantages.

Firstly, the photovoltaic power plant is connected to utility grid without the risk that harmonics or sub-harmonics are transmitted from the photovoltaic power plant into the utility grid.

Moreover, converting the electrical energy and providing a voltage that conforms to the utility grid offers other advantages:

Both the electric motor and the synchronous generator have a rotating mass due to the rotor. This rotating mass stores kinetic energy capable of mitigating power fluctuations of the photovoltaic modules due to brief changes in the incident sunlight, for example due to a cloud, by converting kinetic energy of the rotors and shafts into electrical energy in the event of a sudden power drop.

Synchronous generators have been used since decades to generate grid-compatible electrical energy. The network operators are familiar with the technology and the potential effects of a synchronous generator on a utility grid. A utility grid operator will therefore have few concerns when approving a grid connection of a photovoltaic power plant according to the invention. It can be expected that the utility grid operator will even prefer to connect photovoltaic power plants to a grid, because faults need not be compensated on the side of the grid and, on the contrary, the quality of the available electricity is improved.

In contrast to conventional inverters, reactive power can be stored or controlled in synchronous generators by adjusting the excitation.

Synchronous generators are inherently robust against short circuits and overloads compared to inverters with power semiconductor components.

These significant advantages in the unique combinations were never recognized by the previous planners and developers of photovoltaic power plants. The direction of the art is still looking back to the past and limit the approach to the connection of photovoltaic power plants with inverters having power semiconductor components.

In a photovoltaic power plant according to the invention, at least one of the shafts may be connected to a flywheel mass or a flywheel mass may be driven by one of the shafts. The flywheel mass enables additional storage of kinetic energy, which makes photovoltaic power plant more independent from short-term fluctuations in solar irradiation.

In an advantageous embodiment of the invention, the flywheel mass may be connected to one of the shafts via a clutch. Depending on the position of the clutch, energy can be transferred from the shaft to the flywheel mass, or energy can be transferred from the flywheel mass to the shaft, or the energy remains stored in the flywheel mass. Energy is transmitted when the clutch is engaged. No energy is transported when the clutch is disengaged. Kinetic energy can thus be stored or converted into electrical energy depending on needs.

A photovoltaic power plant according to the invention may have, in addition to the first central converter, a second central converter, namely a central inverter, for converting the direct current that can be generated by the photovoltaic modules into an alternating current. This alternating current may include harmonics and sub-harmonics. The electric motor of the first central converter is then advantageous an asynchronous motor, which receives electrical energy from the central inverter. The central inverter supplies a current that with the present invention is not required to satisfy the feed requirements from a grid operator. However, this is harmless because there is no electrical coupling between the central inverter and the grid. The asynchronous motor is designed so that it is unaffected during operation by harmonics and sub-harmonics occurring at the output of the central inverter. Special filters are hence not required at the output of the central inverter.

A photovoltaic power plant according to the invention may have, in addition to the first central converter, decentralized converters, in particular strand inverters, wherein each strand inverter is connected in a corresponding strand for transforming the DC current to be generated by the photovoltaic modules of a strand into an AC current. The at least one electric motor of the first central inverter of such a photovoltaic power plant may be an asynchronous motor. The strand inverters also supply a current which according the present invention is not required to satisfy the feed requirements from a grid operator. Special filters for attaining a grid-compatible voltage are hence not required at the output of the photovoltaic power plant.

The first central converter may even have several asynchronous motors with interconnected shafts. One or more strands of the photovoltaic power plant are associated with each asynchronous motor, and electrical energy can be supplied to the asynchronous motors via these strands. Shafts of the asynchronous motors may be rigidly connected with one another. Alternatively, the shafts may also be interconnected via clutches and/or gears, also with switchable gears.

The asynchronous motor(s) may be multi-phase asynchronous motors, in particular three-phase asynchronous motors. The number of phases may correspond to the number of the strands of the photovoltaic power plant or may be an integral fraction of the number of strands.

A stator of the asynchronous motor or the stators of the synchronous motors may have more than one pole pair. The number of pole pairs may correspond to the number of strands of the photovoltaic power plant or may be an integral fraction of the number of strands.

Likewise, the electric motor of the first central converter may be a DC motor. A conversion of the DC current produced by the photovoltaic modules into AC current may then be unnecessary.

A transformer may be connected between the first central transformer and the output of the power plant for stepping up the voltage available from the first central converter to the voltage in the utility grid. Such transformers alone which have little effect on the voltage waveform are known, for example, from steam power plants or nuclear power plants.

A photovoltaic power plant according to the invention has the particular advantage that the strands of the photovoltaic power plant may be distributed geographically. The photovoltaic modules associated with the strands may be installed several kilometers apart and the current generated by the modules may be transmitted via lines to the first central converter, optionally by interconnecting an inverter, for conversion into a grid-compliant current. The geographic distribution of the modules has the advantage that the solar photovoltaic power plant becomes less dependent on the local conditions, particularly on weather conditions at a single location. The performance of the photovoltaic power plant is then more uniform than with a photovoltaic power plant that is subject to the conditions at only a single location. Severe changes in the performance can be avoided, which makes it easier for the grid operator to integrate the photovoltaic power plant into the utility grid.

Advantageously, a photovoltaic power plant according to the invention has a power generating capacity of more than 100 kW, and in particular of more than 1 MW. The advantages of a photovoltaic power plant according to the invention will then be become particularly evident.

### BRIEF DESCRIPTION OF THE DRAWINGS

An exemplary embodiment of a photovoltaic power plant according to the invention is described in more detail with reference to the drawing, which shows in

FIG. 1 a schematic circuit diagram of the photovoltaic power plant.

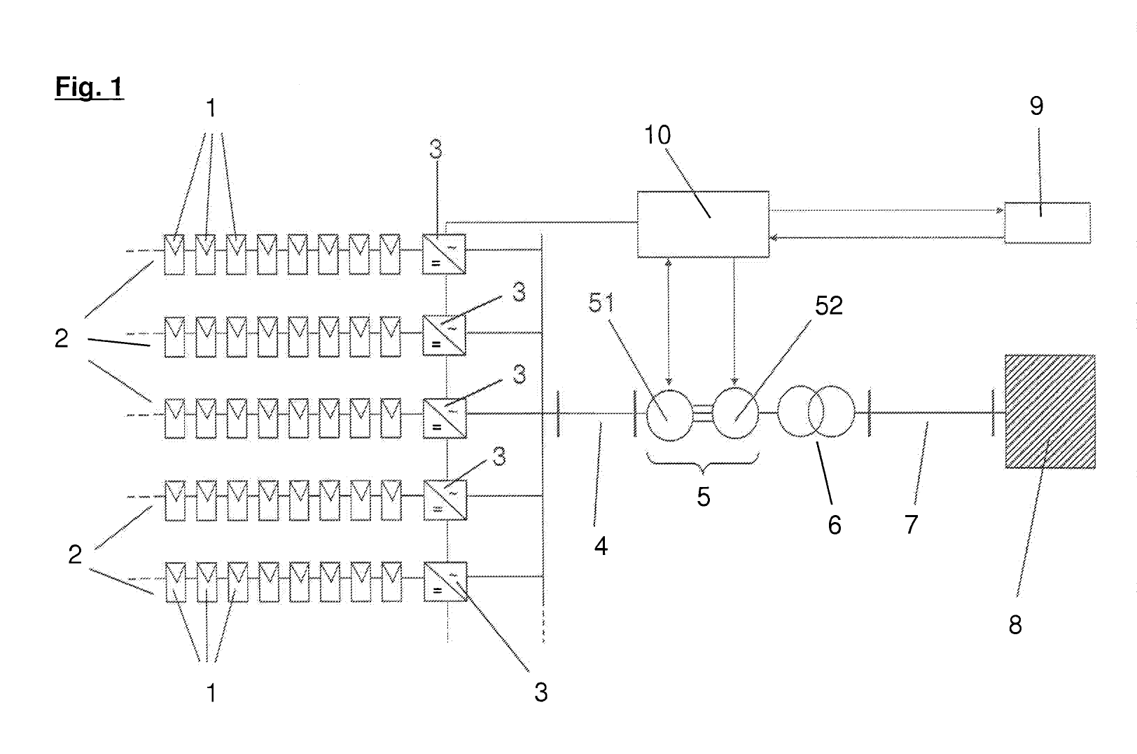

### DETAILED DESCRIPTION OF THE INVENTION

The photovoltaic power plant according to the invention has a plurality of photovoltaic modules 1, which are connected in series in form of a plurality of strands 2. The strands 2 are connected to a strand inverter 3. A voltage of 10 kV is supplied at the outputs of the strand inverter 3. The outputs of the strand inverter 3 are connected via a medium voltage line 4 to a first central converter 5 of the photovoltaic plant. The medium voltage line 4 may include several phase conductors.

The first central converter 5 has an asynchronous machine 51, which may be a multi-phase asynchronous motor with a plurality of pole pairs. The number of phases preferably corresponds to the number of the phase conductors of the medium voltage line 4. The number of pole pairs of the asynchronous machine multiplied by the number of phases may also correspond to the number of strands 2 of the photovoltaic power plant.

A shaft of the asynchronous motor 51 is fixedly connected to a shaft of a synchronous generator 52. The synchronous generator 52 is also part of the first central converter 5. The induction motor 51 therefore drives the synchronous generator 52 and generates an electric current.

A transformer 6 is connected downstream of the synchronous generator 52, wherein the transformer 6 steps up the voltage at the output of the synchronous generator 52 to the voltage of a utility grid, in the present example a transmission grid. The voltage in the transmission grid is for example 110 kV.

This secondary side of the transformer 6 is connected to the transmission grid 8 via a high-voltage line 7 having a voltage of 110 kV. The end of the high-voltage line 7 marks the output of the photovoltaic power plant.

The photovoltaic power plant has a controller or a control room 10, from which the inverter 3, the asynchronous motor 51 and the synchronous generator 52 can be controlled. The control room 10 is connected to a control room 9 of an operator of the transmission grid 8. The control room 10 communicates to the control room 9 of the transmission grid operator the status and availability, i.e., also the power reserves of the photovoltaic power plant. Conversely, the control room 9 of the transmission grid operator communicates to the control room 10 of the power plant operator the reactive power Q to be provided and the active power factor cos φ to be adjusted.

Commensurate with the requirements from the transmission grid operator, the power plant operator controls and regulates the photovoltaic power plant from the control room 10. In particular, the slip of the asynchronous motor and the rotor displacement angle δ and the excitation current I_{E} are controlled or regulated. The performance of the inverter 3 can also be adjusted from the control room.

The network within the photovoltaic power plant is completely galvanically and electromagnetically decoupled from the transmission system 8. The two networks are connected only via the mechanically coupled shafts of the asynchronous machine 51 and the synchronous generator 52. This electromagnetic decoupling essentially prevents faults that occur or may occur within the power grid of the photovoltaic power plant from affecting the transmission system 8. Harmonics and sub-harmonics in the power grid of the photovoltaic power plant are not transmitted via the rotating transformer 5. In addition, the plant has the advantage due to the converter 5 that power fluctuations of photovoltaic power plant have only a weak effect on the transmission grid 8 by the flywheel mass and the inertia of the rotating parts of the converter 5. Because the various strands 2 of the photovoltaic power plant can be geographically distributed, the power of the photovoltaic power plant can be further equalized, since local shadowing of the photovoltaic modules 1 of a strand 2 only partially lowers the power from the photovoltaic power plant, whereas local shadowing with other known photovoltaic power plants can cause a sudden change in output power from the entire power plant.

1. A photovoltaic power plant, comprising
a plurality of photovoltaic modules (1) for generating electric power, connected together into a plurality of strands (2),
a first central converter (5) for converting electrical energy generated by the photovoltaic modules into electrical energy with a voltage having a voltage waveform that corresponds to a voltage waveform of a voltage in a utility grid, and
an output for feeding the converted current into the utility grid, wherein the first central converter (5) has at least one electric motor (51) and a synchronous generator (52) whose shafts are coupled together.

2. The photovoltaic power plant according to claim 1, wherein at least one of the shafts is connected to a flywheel mass or that a flywheel mass can be driven by one of the shafts.

3. The photovoltaic power plant according to claim 2, wherein the flywheel mass is connected via a clutch to one of the shafts and, depending on the position of the clutch, energy is transferred from the shaft to the flywheel mass or energy is transferred from the flywheel mass to the shaft.

4. The photovoltaic power plant according to claim 1, wherein the photovoltaic power plant has, in addition to the first central converter (5), a second central converter in form of a central inverter, for converting the DC current that is generated by the photovoltaic modules (1) into an AC current, and the at least one electric motor (51) of the first central converter (5) is an asynchronous motor.

5. The photovoltaic power plant according to claim 1, wherein the photovoltaic power plant comprises, in addition to the first central converter (5), decentralized converters (3) in form of strand inverters, with each one of the decentralized converters being connected in a strand, for converting the DC current that is generated by a strand (2) of the photovoltaic modules (1) into an AC current, and
the at least one electric motor (51) of the first central converter (5) is an asynchronous motor.

6. The photovoltaic power plant according to claim 5, wherein the first central converter (5) comprises a plurality of asynchronous motors (51) having interconnected shafts.

7. The photovoltaic power plant according to claim 6, wherein one or more strands (2) of the photovoltaic power plant are associated with each asynchronous motor (51) and electrical energy are supplied to the asynchronous motors (51) via these strands (2).

8. The photovoltaic power plant according to claim 4, wherein the asynchronous motor (51) is a multi-phase asynchronous motor.

9. The photovoltaic power plant according to claim 6, wherein the asynchronous motors are three-phase asynchronous motors, the three-phase corresponds to the number of strands (2) of the photovoltaic power plant.

10. The photovoltaic power plant according to claim 4, wherein a stator of the asynchronous motor (51) comprises more than one pole pair.

11. The photovoltaic power plant according to claim 8, wherein the number of pole pairs corresponds to the number of strands (2) of the photovoltaic power plant.

12. The photovoltaic power plant according to claim 1, wherein the electric motor (51) of the first central converter (5) is a DC motor.

13. The photovoltaic power plant according to claim 1, wherein a transformer (6) is connected between the first main converter (5) and the output of the photovoltaic power plant for stepping up the voltage that is supplied by the first central converter (5) to the voltage in the utility grid.

14. The photovoltaic power plant according to claim 1, wherein the strands (2) are geographically distributed.

15. A photovoltaic system according to claim 1, wherein the photovoltaic power plant provides an output power of more than 100 kW.
